(19) United States
(12) Patent Application Publication
(10) Pub. No.: US 2018/0001330 A1
(43) Pub. Date: Jan. 4, 2018

(54) SEPARATOR

(71) Applicant: GEA MECHANICAL EQUIPMENT GMBH, Oelde (DE)

(72) Inventors: Wilfried MACKEL, Lippetal-Herzfeld (DE); Thomas BATHELT, Oelde (DE); Kathrin QUITER, Drensteinfurt (DE); Frank TAETZ, Delbrück (DE)

(21) Appl. No.: 15/545,796

(22) PCT Filed: Jan. 7, 2016
(86) PCT No.: PCT/EP2016/050152

§ 371 Date: Jul. 24, 2017

(30) Foreign Application Priority Data
Jan. 29, 2015 (DE) 10 2015 101 344.4

(51) Int. Cl. B04B 7/02; B04B 15/06; B04B 1/08

(52) U.S. Cl. CPC B04B 7/02; B04B 1/08; B04B 15/06

(57) ABSTRACT

A separator for the centrifugal processing of a flowable product includes a rotatable drum with a vertical rotational axis. The drum delimits a centrifuge chamber and has an arrangement for clarifying the product to be processed in the centrifugal field. The drum consists preferably entirely or partly of plastic or a plastic composite material. A supply system and a discharge system for the drum are formed on or in the drum. A housing in which the drum is arranged and which has a base part, includes a housing casing connected to the base part, and preferably a cover. The housing has at least one first opening configured as a supply opening and/or a discharge opening for a liquid such that the interior of the housing can be easily cleaned and/or disinfected.

### BACKGROUND AND SUMMARY OF THE INVENTION

Exemplary embodiments of the invention relate to a separator.

Centrifugal separators for performing continuous operation have long been known, for example, in one embodiment as nozzle separators, from Japanese patent document JP 62-117649 A. In addition to nozzle separators, there are known separators having solids discharge openings, with which there is associated a hydraulically actuable piston valve by means of which the solids discharge openings may be closed and cleared. U.S. Pat. No. 2,017,734 discloses a separator with no solids discharge, in an embodiment as a separator. Further, U.S. Pat. No. 2,286,354 discloses a separator having solid drum lower and upper parts that are screwed together.

Moreover, PCT International patent document WO 2014/000829 A1 discloses a generic separator for separating a flowable product into different phases or for clarifying a product, which has a rotatable drum having a drum lower part and a drum upper part, and a device, arranged in the drum, for clarification, wherein one, a plurality or all of the following elements are made from plastics or a plastics composite material: the drum lower part, the drum upper part, the device for clarification. In this way, it is possible to devise a part of the drum or preferably even the entire drum—preferably together with the infeed and drainage systems or regions—for single use, which is particularly useful and advantageous for processing pharmaceutical products, such as fermentation broths or similar, since, in an operation that is preferably continuous during processing of the product batch, after the operation for processing a corresponding product batch there is no need for the drum to be cleaned but rather the drum can be replaced as a whole. From the hygienic point of view alone, this separator is consequently very advantageous.

Exemplary embodiments of the invention are directed to making it is possible to rinse, in particular to disinfect, the internal chamber of the housing in a simple manner.

According to an embodiment, a separator for centrifugal processing of a flowable product, has at least the following features: a rotatable drum, which has a vertical axis of rotation, delimits a centrifugal chamber and has a device, arranged in the drum, for clarifying the product to be processed in the centrifugal field, wherein the drum is preferably made entirely or partly from plastics or a plastics composite material, wherein the infeed system and the drainage system are constructed on or in the drum, and which has a housing in which the drum is arranged and that has a base part, a housing shell, connected to the base part, and preferably a cover, and wherein the housing has at least a first opening that is devised at least as an infeed opening and/or a drainage opening for a liquid. It is possible to utilize one and the same opening as an infeed opening and a drainage opening. As an alternative, at least one infeed opening and at least one drainage opening may be provided in the housing separately. In that case, it is favorable if the housing has at least a second opening that is configured as a drainage opening. It is also conceivable and advantageous to provide a second opening as a venting opening.

It is further advantageous and structurally simple if one of the openings, as the infeed opening, is arranged vertically higher up in the housing than the other opening, which then preferably serves as the drainage opening.

Exemplary embodiments of the invention are also directed to making it possible to rinse the housing with a liquid in a simple manner. According to the inventive method, the housing is accordingly filled with a liquid at least once or a plurality of times, and (after a predetermined period or within the context of a flushing cycle with a pump) this liquid is in each case drained out of the housing again.

If a liquid having a disinfectant action is used as the liquid, then, in a simple manner, the rinsing has the effect of disinfecting, with an action corresponding to the property of the liquid, at least a partial region of an internal chamber of the housing. Preferably, a cleaning of this kind is performed at the time of or after a drum change.

Favorably and advantageously, one of the openings, as the infeed opening, is constructed or arranged vertically higher up in the housing than another opening, which is utilized as the drainage opening. It is further favorable if the infeed opening and/or the drainage opening is/are each closable by a closing device. It is also conceivable for hoses or similar to be connectable thereto in order to enable a liquid to be moved in a cycle.

It is further advantageous if the housing is devised to be sealed such that, when the drum is not rotating and the drainage opening is closed, it may be filled with a liquid without any of this liquid being able to escape downward out of the housing. Preferably, the housing is devised to be sealed such that, when the drum is not rotating and the drainage opening is closed, it may be filled with a liquid to the vertical level of the infeed opening, such that it may also be disinfected to this level.

In order to properly achieve the required sealing using simple devices, it is further advantageous if there is arranged, between a drive spindle for the drum and a feedthrough in the housing for the drive spindle, a sealing ring that is variable in cross section and may, for example, be filled with fluid, in particular being capable of being pumped up.

Sealing strips or similar may be provided in supplementary manner between component parts of the housing.

Preferably, a cover of the housing takes the form of a covering annular body. If the cover is a covering annular body that can be inserted vertically into the housing from below and pushed entirely or in certain regions through the opening in the cover, it becomes considerably easier to change the drum that is made from plastics or the parts of the drum that are made from plastics by an interaction with the plane that divides the base part and the housing shell. This is because, by releasing this dividing plane, the drum is accessible and, in order to change the drum, the cover may be removed upward from the drum and the covering annular body without the need to detach the covering annular body from the drum. The cover could also take a divided form, wherein the opening is completely closed all the way around only once it is in the assembled condition. In that case the feature of being able to be placed on the cover relates to the assembled condition thereof.

Here, it is advantageous if the drum has an outer support device and an inner drum that is arranged in the support device, in that the device for clarifying the product to be processed in the centrifugal field is arranged in the inner drum. Preferably, the outer support contour takes the form of an outer drum in which the inner drum is arranged, wherein the outer drum has an outer drum lower part and an outer drum upper part, and wherein the inner drum has an inner drum lower part and an inner drum upper part.

According to a further development, the dividing plane between the base part and the housing shell is flush with a dividing plane between the outer drum upper part and the outer drum lower part, or there is an offset of less than 250 mm between the two dividing planes. In this way, the interface between the outer drum upper part and the outer drum lower part is particularly readily accessible, which makes it considerably easier to change the inner drum—which is preferably a disposable drum for processing a product batch, for example in the pharmaceutical or chemical sector.

Since the drum has an outer support device and a drum—called the inner drum—that is arranged within the support device, and the device for clarifying the product to be processed in the centrifugal field is arranged in the inner drum, the running behavior of the rotating system, in particular that of the drum, is moreover significantly improved in a simple manner, because the outer support device stabilizes the system. Because this support device is radially outward of the drum wall that delimits the drum internal chamber, the actual drum that delimits the centrifugal chamber will be called the “inner drum” below.

According to a variant, the outer support contour takes the form of an outer ring axially surrounding the inner drum in certain regions. A ring of this kind, in the manner of a “binding”, stabilizes the construction at the outer periphery. The at least one stabilizing ring (or the plurality of rings) is preferably made from metal, but may also be made from a plastics or a plastics composite material or similar. It is also conceivable to provide a contour, for example a ring-like pocket that is axially open in one direction, on the outer periphery of the inner drum, into which the stabilizing ring is inserted.

Further, according to a preferred embodiment, it is advantageous if the outer support contour takes the form of a peripherally closed outer ring that surrounds the inner drum axially in certain regions. However, it is also conceivable for the outer support contour to take the form of a lattice-like outer ring that surrounds the inner drum over a certain axial region.

It is further particularly advantageous if the outer support contour takes the form of an outer drum surrounding the inner drum entirely or in certain regions. In this way in particular, the running behavior of the rotating system, in particular that of the drum, is significantly improved in a simple manner because the outer drum dynamically and mechanically stabilizes the system. It is possible to significantly reduce both deflection of the rotating system in the radial direction relative to the axis of rotation D and also the tendency to unbalance. Both the inner drum and also the support construction may—but need not—take a relatively thin-walled form. In particular, the inner drum, which is preferably to be changed once a product batch has been processed, may consequently be made in a manner saving on material.

However, it remains possible to utilize the advantages of the fact that the material is plastics or plastics composite material, since it is still possible for part of the drum—the inner drum and preferably its component parts—in particular together with the infeed and drainage systems and regions—to be devised for single use, such that after the operation for processing a corresponding product batch, in an operation that is hygienic and preferably continuous during processing of the product batch, there is no need to clean the drum, but rather the drum is replaced as a whole. This replacement takes a particularly simple form because the outer drum, which is preferably re-used, does not need a major clean, since preferably it does not come into contact with the product for processing at all. For this reason, it need not be cleaned and/or disinfected every time the inner drum is changed, or this cleaning and/or disinfecting need only be relatively short.

It is also possible for changing the inner drum and mounting, demounting and other handling thereof to be carried out in a simple manner as, since there is a stable outer drum construction into which the inner drum need only be inserted, it is possible to provide the drive connection to an electric motor only at the outer drum, with the result that when the inner drum is changed it need only be taken out of the outer drum and another inner drum inserted therein again, without numerous complex mounting steps, such as making a drive connection with the drive shaft, being required for this.

It is particularly advantageous if the inner drum and the outer drum are made from different materials, since in this way the optimum materials can be selected in each case for the two elements, outer drum and inner drum. Preferably, the inner drum is made from a plastics or a plastics composite material, which is once again preferably relatively thin-walled, with the result that it can be disposed of easily, and the re-usable outer drum is made from metal, in particular steel, with the result that its running properties can be optimized particularly well.

It is also advantageous in this context that, if a metal outer drum and an inner drum made from plastics are used, the weight of the outer drum can significantly exceed that of the inner drum, with the result that the rotational behavior is substantially determined by the outer drum. Preferably, for this purpose, the weight of the rotating parts of the metal outer drum is more than twice as much, in particular more than four times as much, as the weight of the rotating parts made from plastics, or the weight of the empty inner drum. As a result of the outer drum, it is also possible to make the inner drum particularly thin-walled, since it is stabilized by the outer drum.

In order to achieve secure rotation, as far as possible with no slip between the inner drum and the outer drum, it is advantageous if the inner drum and the outer drum are connected force-fittingly and/or form-fittingly such that they cannot rotate in relation to one another.

For reasons of hygiene, it is conceivable for an infeed system and a drainage system of the drum to be formed exclusively on the inner drum, such that the outer drum does not come into contact with the product to be processed during operation. According to one type of construction, the infeed system and the drainage system are formed in a sealed type of construction on the inner drum. Other embodiments of the infeed and drainage system, for example with one or more paring disks and a non-rotating infeed tube that projects into the drum, are likewise conceivable.

Overall, for reasons relating to handling, it is particularly advantageous if the entire inner drum, together with the infeed and drainage system, is devised as a replaceable pre-mounted module made from plastics or a plastics composite material. However, it is also conceivable to provide, locally and in a delimited manner, reinforcements (additional ones, besides the support construction, in particular the outer drum) made from metal, for example in the region of seals, in particular in the form of sleeves for reinforcing the pipes on the inside and/or the outside of the seals. These are where appropriate separated off during recycling or disposal.

As a whole, and also with the concept of the inner drum, some of the and preferably even all of the regions of the rotating system contacting the product are made from a plastics or a plastics composite material, in particular the inner drum lower part and the inner drum upper part and the disk stack. Particularly preferably, the infeed system and the drainage system are further made from plastics or a plastics composite material.

Here, it is further particularly advantageous if the inner drum lower part and the inner drum upper part are non-detachably connected to one another at the time of first mounting, in order to prevent an attempt to demount them and where appropriate use them again after insufficient cleaning. Instead, the inner drum is entirely disposed of or recycled. Here, it is also advantageous that sterility is ensured. The construction is preferably such that before installation and after dismantling no air can penetrate into the inner drum from outside.

It is furthermore possible with the concept of the inner drum to devise a part of the drum or preferably even the entire drum—preferably together with the infeed and drainage systems or regions—for single use, which is particularly useful and advantageous for processing pharmaceutical products, such as fermentation broths or similar, because, in an operation that is preferably continuous during processing of the product batch, after the operation for processing a corresponding product batch there is no need for the drum to be cleaned but rather the drum is replaced as a whole. Problems of hygiene associated with cleaning are thus eliminated in a simple manner. The parts in contact with the product may be disposed of or recycled in their entirety. Disposal is also particularly useful in the case of hazardous substances. It is once again also conceivable, in the case of a product clarifying procedure, primarily to carry out concentration of a product to be processed and to melt down the inner drum after a batch has been processed, or for example to break it down in an acid or similar, in order to recover the heavy substance as a residue from this procedure. By using preferably thin-walled plastics parts, it is moreover possible to keep the manufacturing costs relatively low.

Preferably, there is used as the plastic a recyclable plastic, in particular PE (polyethylene), PP (polypropylene) or SC PEEK (in particular semi-crystalline) polyether ether ketone. Further conceivable are, among others (and this is not a comprehensive list), the materials PC (polycarbonate), MABS (methyl methacrylate acrylonitrile butadiene styrene), ABS (acrylonitrile butadiene styrene) and PSU (polysulfone).

### BRIEF DESCRIPTION OF THE DRAWING FIGURES

The invention will be described in more detail below by way of exemplary embodiments and with reference to the figures, in which:

FIG. 1 shows in a) a view of a separator according to the invention with a direct drive and with the housing and drum illustrated in section, and in b) an enlarged detail from a).

### DETAILED DESCRIPTION

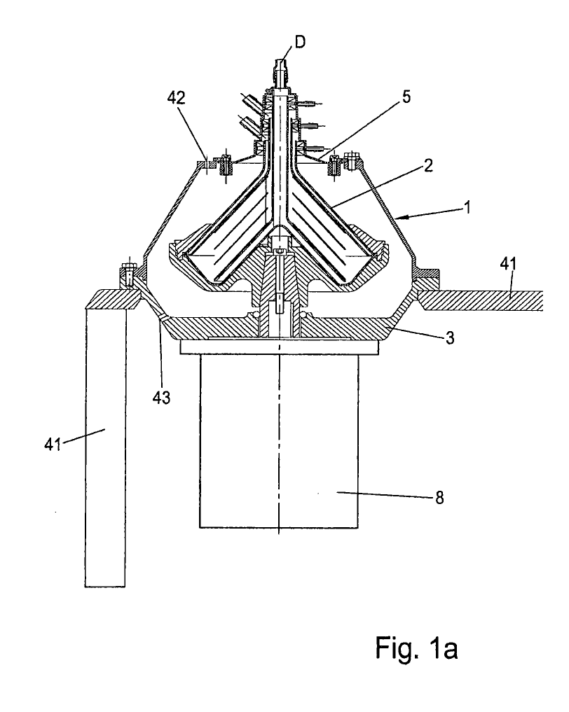

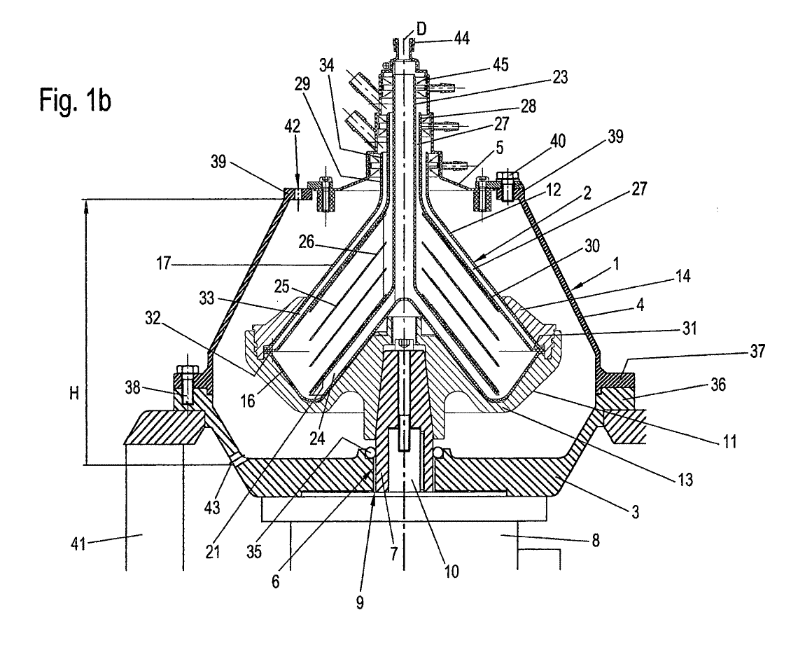

FIG. 1a shows a section through the region of a housing 1 and a drum 2 of a separator according to the invention by means of which a liquid product can be separated into two phases in the centrifugal field. The drum 2 has a vertical axis of rotation D. Terms such as “top” or “bottom” that are used below relate to the orientation of elements of the separator in relation to this vertical axis of rotation.

The drum 2 is devised entirely or partly as a so-called disposable drum, which is devised only for single use. This means that it is used to process a single product batch and that it is then preferably exchanged. A preferred embodiment of the drum 2 will be explained in more detail below.

The housing 1 has a lower base part 3, a housing shell 4 and an upper cover 5.

According to FIG. 1, the base part 3 and the housing shell 4 and the cover 5 each take a conical form in certain regions. However, other geometries are also conceivable for these elements, such as a hemispherical shape for the unit comprising the elements base part 3 and housing shell 4 and a cover 5 that is connected thereto (where appropriate also being in one piece therewith). In particular, the housing shell 4 could moreover also take a form that is cylindrical or polygonal, in particular square, in section (perpendicular to the axis of rotation D; FIG. 1, FIG. 2).

The base part 3 has a feedthrough 6, through which a rotatable drive spindle 7 passes. Preferably, a drive motor 8 is arranged directly below the base part 3. This drive motor 8 serves to drive the drive spindle 7. Alternative embodiments are conceivable, for example one in which the drive spindle 7 is driven by a drive belt or similar, in which case the drive motor is arranged at a different location. However, a direct drive, in particular in the manner of FIG. 1a, in which the drive shaft of the motor is arranged directly as a vertical extension of the drive spindle 7, is preferred. Here, a separate bearing for the spindle construction is preferably dispensed with, which makes it possible to carry out the construction simply and relatively inexpensively. This construction is simple and robust, and very well suited to the lightweight drum construction. The function of bearing the drum is assumed by the electric motor or the rotor bearing thereof in a simple manner.

The drum 2 is once again placed on the vertical upper end of the drive spindle 7 such that it cannot rotate in relation thereto, with the result that it can be set in rotation by the drive spindle 7 and the drive motor 8.

The drive spindle 7 could be rotatably mounted in the housing 1, in this case in the base part 3, by means of one or more bearings. Here, however, a bearing of this kind is advantageously dispensed with. Rather, a gap 9 is formed between the outer periphery of the drive spindle and the inner periphery of the feedthrough 6 of the base part 3.

In this way, a bearing of a drive shaft 10 in the motor housing of the drive motor 8, on which the drive spindle 7 is fixed or on which it is formed in another way, may also be utilized in a simple way for bearing the entire rotating system comprising the drum 2 and the drive spindle 7. Thus, it is also preferred for the drive spindle 7 to be coupled directly to the take-off shaft of the motor and for the drive spindle 7 not to have a rotary bearing—for example a neck bearing or foot bearing—at its outer periphery. Preferably, no spring system for a resilient support in the region of the drive spindle is provided either.

A sealing ring 35 of variable cross section—preferably being capable of being pumped up—ensures that the gap 9 is sealed when the drum is not rotating.

Here, the cover 5 takes the form of a covering annular body forming an integral component part of the infeed and drainage system and has therefore also to be changed when the drum is changed. This is advantageous but not mandatory.

Here, the base part 3 takes the form of a base plate having an upward conical attachment. The housing shell 4 is arranged on the base part 3. Here, an edge region of the base part 3 serves as a flange-like support face—flange portion 36—for a lower flange portion 37 of the housing shell 4. The base part 3 and the housing shell are screwed to one another—preferably in the flange region—by screws 38 that are distributed around the periphery. Further, the housing shell 4 has an upper flange portion 39 onto which the cover 5 is fixedly screwed by screws 40.

The flange regions may take a stepped form. It is also conceivable to provide a peripheral seal (not illustrated here) between them. The base 3 may be utilized for support against an abutment 41 (here illustrated only schematically), such as a foundation or a machine frame.

It is particularly advantageous that the housing 1 has in each case at least one opening 42 as a (preferably vertically upper) infeed opening and/or drainage opening. Preferably, at least a second opening 43 is also provided, which in this case is arranged, for example and advantageously preferably, vertically further down in relation to the infeed opening.

One or both of the openings 42, 43 can be devised to be closable. Preferably, suitable closure devices such as screws or similar (not illustrated here) serve for closing.

A liquid, in particular a cleaning and/or disinfecting liquid, can be introduced into the housing 1 through the one or through one of the openings 42. This introduction may be performed by pumping the liquid in or by filling through an opening that is arranged far enough up to fill the housing 1 sufficiently or even entirely.

For this purpose, the housing 1 is preferably—including as well the openings 42, 43—formed to be sealed such that it can be filled with the liquid in the axial direction up to the level H when the drum 2 is not rotating or not present and when the drainage opening 43 is closed, without any of the liquid escaping from the housing. A vent, in particular a venting opening provided particularly for this purpose, can be provided above the maximum liquid level to be provided, so that the filling can be performed.

The further opening 43 may be utilized as a drainage opening. For this purpose, it is preferably arranged such that it enables the entirety of the introduced liquid to be drained off downward when it is opened. As an alternative, the liquid can be pumped away.

Liquid of this kind—which may arise in the housing, for example, as a result of an unforeseen leak—can flow out through the opening 43, in this case a drainage opening. For this purpose, a discharge line, such as a drainage hose, for discharging this liquid into a container, can be arranged on a connection piece (not illustrated here) of the opening 43.

In this way, the housing 1 surrounding the drum 2 can be cleaned in a simple manner and in particular even disinfected and where appropriate sterilized using a suitable liquid, in particular a sterilization liquid.

This cleaning is performed, for example, advantageously on changing the drum, when the drum is not present. However, it is also possible to perform a cleaning of this kind at another time, for example after a new drum has been inserted.

Further features of the preferred construction will be explained in more detail below.

A particularly compact construction is achieved in that—as already mentioned at the outset—the drive motor is preferably an electric motor arranged directly as an axial extension of the drive spindle 7, preferably on the side remote from the drum. Preferably, the drive spindle 7 is axially connected directly to the drive shaft 10 by means of a pin. It is further connected in the peripheral direction by means of a torque-transmitting device, preferably a key, to the take-off shaft of the electric motor such that it cannot rotate in relation thereto (not illustrated here). The torque-transmitting device may also take a different form—for example a torque-transmitting contour (not illustrated here).

The structure of the drum 2 will now be explained below in more detail. This differs considerably from the structure of known constructions.

This is because the drum 2 has an outer drum 11, which may also take the form of an outer drum portion, and an inner drum 12. The inner drum 12 is replaceably inserted into the outer drum 11.

Preferably, the outer drum portion or outer drum 11 and the inner drum 12 are made from different materials. Particularly preferably, the outer drum 11 is made from metal, in particular steel, and the inner drum 12 is made preferably entirely or at least partly from a plastic or a plastics composite material.

Here, the outer drum 11 serves as a type of mounting into which the inner drum 12 is inserted and which surrounds or encloses the inner drum 12 in the vertical or axial direction, at least in certain regions over its entire periphery. Particularly preferably, the outer drum 11 and the inner drum 12 are connected such that they cannot rotate in relation to one another. This may be achieved in particular by a form-fit and/or force-fit between the outer drum 11 and the inner drum 12.

The outer drum 11 has an outer drum lower part 13 that may be or in this case is constructed substantially like the drum lower part of known separators, without an inner drum. The outer drum lower part 13 is placed on the drive spindle 7 such that it cannot rotate in relation thereto, and preferably has, on the inside, an internal shape that is a simple cone, or in this case particularly preferably a double cone. The outer drum 11 further preferably has an outer drum upper part 14. Preferably, the outer drum lower part 13 and the outer drum upper part 14 have corresponding threads, in the region whereof they are screwed directly to one another.

The outer drum upper part 14 likewise takes a conical form. It is further in the form of a ring that is connected at the bottom to the outer drum lower part 13 such that it cannot rotate in relation thereto and takes an upwardly open form such that the inner drum 12 projects vertically or axially upward out of the outer drum, in this case the outer drum upper part 14.

Because the outer drum lower part 13 and the outer drum upper part 14 are preferably made from metal, in particular steel, and preferably at least the drum lower part is constructed like that of a separator drum without an inner drum 12, they can largely provide the smooth running and stability and reliability of a known modern separator drum made from metal.

By contrast, the inner drum 12 outwardly delimits the actual separating or centrifugal chamber 15 for centrifugal processing of a flowable product.

As far as its shape is concerned, the inner drum 12 is constructed such that it abuts preferably largely form-fittingly and directly against the inner periphery of the outer drum. The inner drum 12 has an inner drum lower part 16 and an inner drum upper part 17. Preferably, the inner drum lower part 16 and the inner drum upper part 17 each take a conical form, with the result that a body in the shape of a double cone is formed. Parts 16 and 17 are made from plastics or a plastics composite material and are connected to one another in liquid-tight manner, in particular in upper (inner drum lower part 16) and lower (inner drum upper part 17) flange regions 18, 19 (see FIG. 1b).

Preferably, a connection forming a substance-to-substance bond is provided between the inner drum lower part 16 and the inner drum upper part 17 and where appropriate further elements of the inner drum 12, a connection which in the context of this specification may be achieved for example by fusing or indeed gluing. Other types of connection are also conceivable, such as a bayonet closure between the elements to be connected, the inner drum lower part 16 and the inner drum upper part 17, or screw connections using plastics screws and nuts or similar (not illustrated here). A favorable connection is also one in which the inner drum lower part and the inner drum upper part are clamped together at their outer periphery using one or more clamps (not illustrated here). These types of connections between the inner drum parts 16, 17 are easy to handle, inexpensive to achieve and yet highly functionally reliable. The elements may also—as an alternative or in addition—be welded to one another.

Adjoining a portion 20, at the bottom here, of the inner drum lower part 16 there is, axially upwardly as a separate part or connected in one piece with the inner drum lower part and coaxially surrounding the axis of rotation D, a distributor 21, in particular a distributor attachment, which forms a complete distributor for introducing the material for centrifuging into the inner drum internal chamber or centrifugal chamber 15 and for accelerating the material for centrifuging in the peripheral direction when the drum 2 rotates.

Formed in the distributor, in particular the distributor attachment 21, in the upper region there is for example a bore, in the manner of a blind hole, into which an infeed tube 23 opens. The infeed tube 23 and the distributor attachment 21 here form an infeed system, which is preferably and advantageously devised to be sealed from the environment. The infeed tube 23 projects axially, preferably upward, out of the inner drum upper part 17 and rotates with the drum 2 during operation.

At the lower end, the distributor attachment 21 opens into one or more distributor channels 24, which are formed obliquely to the axis of rotation and open, in this case likewise obliquely, into the actual centrifugal chamber 15.

Arranged in the centrifugal chamber 15 are separating devices or devices for clarifying, such as in particular a one-piece or preferably multiple-piece disk stack 25 that takes the form of a stack of axially spaced separating disks 26 that are conical in their basic shape and are placed on the distributor attachment 21, preferably such that they cannot rotate in relation thereto. The separating devices for clarifying could also take a different shape, for example as ribbed bodies with radial or arcuate ribs. The separating disks 26 have the same or different radii.

The distributor 21 may also be formed in one piece with the device for clarifying, if the latter takes the form of a clarifying insert made from plastics, with clarifying chambers, in the manner disclosed in German patent document DE 10 2008 052 630 A1. In the drum 2, product that is introduced into the inner drum internal chamber or centrifugal chamber 15 is separated into different, preferably two, product phases of different density. To discharge the different product phases from the drum 2, there serves a drainage system having two or more drainage regions.

Thus, a lighter liquid phase flows radially inward and is fed there (see FIG. 1b) in a channel 27 on the outside of the distributor attachment 21, axially upward into an annular channel 28 that is formed between the outer periphery of the infeed tube 23 and a piece of tube 29 of larger diameter that also projects upward into the inner drum upper part 17.

At the bottom, attached to this tube piece 29, in particular being glued or integrally formed thereon, is a conical disk that is arranged above the separating disk stack in the manner of an upper parting disk 30, wherein it is spaced from the drum upper part such that a gap is formed between the drum upper part and the parting disk. At the lower end here, a flange-like peripheral edge 31 (see FIG. 1b) is placed between the flange regions 18 and 19 of the inner drum lower part 16 and the inner drum upper part 17 and is preferably firmly glued to these, which stabilizes the arrangement of the parting disk 30 and also provides the entire construction with additional strength.

A heavier liquid phase (or a solid phase that is still just capable of being drained, in particular is still just slightly flowable) is fed from the region of the largest internal periphery of the drum internal chamber through one or more bores 32 in the radially outer region of the parting disk and into the gap 33 that serves as a channel between the inner drum upper part 17 and the parting disk, preferably being fed into a second annular channel 34 between the tube piece 29 surrounding the infeed tube and an axial tube attachment of the inner drum upper part 17.

The heavier and the lighter liquid phases flow upward out of the annular channels 28, 34, in each case into annular channels arranged axially above one another in the cover or the covering annular body 5, which is fastened to the housing 1 such that it cannot rotate (in a manner described in more detail below). It is advantageous that, in this way, nozzles leading radially out of the drum or similar for draining solids are dispensed with, with the result that there is no contact between the interior of the drum and the drum environment in the container 5.

The covering annular body 5 is preferably of stepped construction and has in its vertically topmost region a connection piece 44 as the way of connecting an infeed line (which is visible in FIG. 1b and is described in more detail below). Starting from the connection piece, the covering annular body 5 widens stepwise. Here, the infed material for centrifuging that is to be processed is transferred into the rotating system in a simple manner. Each of the annular spaces 34 is delimited downward preferably in each case by a sealing arrangement 45 on one or more (in this case two) sealing rings are arranged between the outer periphery of the respectively inner tube (e.g. 23) and the inner wall of the annular chamber. As the sealing arrangements 45, preferably in each case two sealing rings that are axially spaced from one another are provided, in particular in the manner of mechanical seals.

FIG. 1 shows an embodiment as a two-phase separating machine (separation of a product into liquid/liquid phases); three-phase machines (for separation into three phases) are likewise achievable (not illustrated here). The product is preferably but not necessarily a fermentation broth to be concentrated.

The rotatable drum 2 may be connected to the drive spindle construction 7 by means of a press-fit part (e.g. in a conical portion), or by means of another torque-transmitting device (not illustrated here). Here, the motor 8 is further fastened on its side facing the drive spindle 7 to a flange portion 50 on the base part of the housing 1, for example being screwed on by means of threaded bolts.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

Housing 1

Drum 2

Base part 3

Housing shell 4

Cover 5

Feedthrough 6

Drive spindle 7

Drive motor 8

Gap 9

Drive shaft 10

Outer drum portion 11

Inner drum 12

Outer drum lower part 13

Outer drum upper part 14

Centrifugal chamber 15

Inner drum lower part 16

Inner drum upper part 17

Flange regions 18, 19

Portion 20

Distributor attachment 21

Infeed tube 23

Distributor channels 24

Disk stack 25

Separating disk 26

Channel 27

Annular channel 28

Tube piece 29

Parting disk 30

Peripheral edge 31

Bores 32

Gap 33

Annular channel 34

Sealing ring 35

Flange portion 36

Flange portion 37

Screws 38

Flange portion 39

Screws 40

Abutment 41

Opening 42

Opening 43

Connection piece 44

Sealing arrangement 45

Vertical axis of rotation D

1-24. (canceled)

25. A separator for centrifugal processing of a flowable product, comprising:
a rotatable drum having a vertical axis of rotation delimits a centrifugal chamber and includes a device, arranged in the drum, for clarifying the product to be processed in a centrifugal field, wherein the drum is made entirely or partly from plastics or a plastics composite material, wherein an infeed system and a drainage system for the drum are constructed on or in the drum,
a housing in which the drum is arranged and having a base part, a housing shell, connected to the base part, and a cover,
wherein the housing has at least a first opening that is configured as an infeed opening and/or a drainage opening for a liquid.

26. The separator of claim 25, wherein the housing has at least a second opening configured as a venting opening.

27. The separator of claim 25, wherein the housing has at least a second opening configured as a drainage opening.

28. The separator of claim 25, wherein the at least one opening includes an infeed opening and at least another opening, and the infeed opening is arranged vertically higher up in the housing than the at least another opening.

29. The separator of claim 25, wherein the first opening is closable by a closing device.

30. The separator of claim 25, wherein a line and/or a pump is connectable to the first opening.

31. The separator of claim 25, wherein the housing is configured to be sealed such that, when the drum is not rotating and the drainage opening is closed, the drum is fillable with a liquid.

32. The separator of claim 25, wherein the housing has an infeed opening and a venting opening and the housing is configured to be sealed such that, when the drum is not rotating and the drainage is closed, the drum is fillable with a liquid to a vertical level of the venting opening.

33. The separator of claim 25, wherein a sealing ring is arranged between a drive spindle for the drum and a feedthrough in the housing for the drive spindle, wherein the sealing ring has a variable cross-section and is configured to be pumped with fluid.

34. The separator of claim 25, wherein the drum has an outer support device and an inner drum arranged in the outer support device, and in that the device for clarifying the product to be processed in the centrifugal field is arranged in the inner drum.

35. The separator of claim 34, wherein the outer support device is an outer drum in which the inner drum is arranged, wherein the outer drum has an outer drum lower part and an outer drum upper part, and wherein the inner drum has an inner drum lower part and an inner drum upper part.

36. The separator of claim 35, wherein a dividing plane between the base part and the housing shell is flush with a dividing plane between the outer drum upper part and the outer drum lower part, or there is an offset of less than 250 mm between the two dividing planes.

37. The separator of claim 34, wherein the outer drum axially surrounds the inner drum only in certain regions.

38. The separator of claim 34, wherein the outer drum axially surrounds the inner drum only in certain regions, and the outer drum has a central opening configured so that the cover may be axially guided.

39. The separator of claim 34, wherein inner drum projects vertically out of the opening in the outer drum.

40. The separator of claim 34, wherein the inner drum and the outer drum are made from different materials, wherein the inner drum is made from plastics or a plastics composite material, and wherein the outer drum is made from steel.

41. The separator of claim 35, wherein the outer drum upper part is a ring that an axially upwardly open form such that the inner drum upper part projects axially out of the outer drum upper part.

42. The separator of claim 25, wherein the device for clarifying is a disk stack comprising a stack of separating disks made from plastics or a plastics composite material.

43. The separator of claim 34, wherein an infeed system and a drainage system of the rotatable drum are formed exclusively on the inner drum.

44. The separator of claim 34, wherein, in a wall of the inner drum, there are no solids discharge openings leading radially out of the inner drum and into an environment around the inner drum.

45. The separator of claim 25, wherein the infeed system and the drainage system have, as the cover, a covering annular body that does not rotate with the rotatable drum during operation.

46. The separator of claim 25, wherein the housing is filled with a liquid that is drained out of the housing.

47. The separator of claim 46, wherein the liquid has a cleaning action, and a rinsing has an effect of cleaning a partial region of an internal chamber of the housing.

48. The separator of claim 46, wherein the liquid is a liquid having a disinfectant action, and the rinsing has the effect of disinfecting a partial region of an internal chamber of the housing.
